(19) United States
(12) Patent Application Publication
(10) Pub. No.: US 2026/0116403 A1
(43) Pub. Date: Apr. 30, 2026

(54) Vehicle-to-Vehicle Control Assistance

(71) Applicant: Nissan North America, Inc., Franklin, TN (US)

(72) Inventors: Pratham Oza, San Jose, CA (US); Viju James, Fremont, CA (US)

(21) Appl. No.: 18/932,830

(22) Filed: Oct. 31, 2024

(51) Int. Cl. B60W 50/02; B60W 10/18; B60W 10/20; B60W 60/00; G08G 1/00

(52) U.S. Cl. CPC B60W 50/0225; B60W 10/18; B60W 10/20; B60W 50/0205; B60W 60/001; G08G 1/22; B60W 2050/0215; B60W 2556/65; B60W 2756/10

(57) ABSTRACT

An apparatus of a first vehicle includes a processor configured to detect a fault associated with a second vehicle. The processor is configured to obtain sensor data associated with a sensing region of the second vehicle. The processor is configured to provide an output, based on the sensor data, for controlling the second vehicle to traverse a vehicle transportation network

### TECHNICAL FIELD

This disclosure relates generally to vehicle operational management and driving, and more particularly to real-time or near real-time control of a vehicle when a precise location of a lane is not available in real time.

### BACKGROUND

A vehicle may traverse a portion of a vehicle transportation network (e.g., a road). Traversing the portion of the vehicle transportation network may include generating or capturing, such as by a sensor of the vehicle, data, such as data representing an operational environment, or a portion thereof, of the vehicle. Traversing the portion of the vehicle transportation network may include performing an action of autonomous driving in response to the captured data. The action may be selected using artificial intelligence (e.g., trained machine-learning models) or other decision-making models.

### SUMMARY

Disclosed herein are aspects, features, elements, implementations, and teachings using belief state determination for real-time decision-making while a vehicle is traveling through a vehicle transportation network.

Some implementations include an apparatus of a first vehicle. The apparatus includes a processor configured to detect a fault associated with a second vehicle. The processor is further configured to obtain sensor data associated with a sensing region of the second vehicle. The processor is further configured to provide an output, based on the sensor data, for controlling the second vehicle to traverse a vehicle transportation network.

Some implementations include a method for use with a first vehicle. The method includes detecting a fault associated with a second vehicle. The method further includes obtaining sensor data associated with a sensing region of the second vehicle. The method further includes providing an output, based on the sensor data, for controlling the second vehicle to traverse the vehicle transportation network.

Some implementations include a first autonomous vehicle. The first autonomous vehicle includes a processor configured to execute instructions stored on a non-transitory computer readable medium to detect a fault associated with a second autonomous vehicle. The processor is further configured to execute the instructions to obtain sensor data associated with a sensing region of the second autonomous vehicle. The processor is further configured to execute the instructions to provide an output, based on the sensor data, for controlling the second autonomous vehicle to traverse the vehicle transportation network.

Variations in these and other aspects, features, elements, implementations, and teachings of the methods, apparatus, procedures, and algorithms disclosed herein are described in further detail hereafter.

### BRIEF DESCRIPTION OF THE DRAWINGS

The various aspects disclosed herein will become more apparent by referring to the examples provided in the following description and drawings in which like reference numbers refer to like elements.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a diagram of an example of an autonomous vehicle operational management system in accordance with embodiments of this disclosure.

FIG. 4 is a flow diagram of an example of using a first vehicle to facilitate control of a second vehicle in accordance with embodiments of this disclosure.

FIGS. 5A-5D are diagrams associated with using a first vehicle to facilitate control of a second vehicle in accordance with embodiments of this disclosure.

FIG. 6 is a flow chart of a method for use with a first vehicle to facilitate control of a second vehicle in accordance with embodiments of this disclosure.

### DETAILED DESCRIPTION

A vehicle, such as an autonomous vehicle (AV), or a semi-autonomous vehicle, may traverse a portion of a vehicle transportation network. The vehicle may include one or more sensors and traversing the vehicle transportation network may include the sensors generating or capturing sensor data, such as sensor data corresponding to an operational environment of the vehicle, or a portion thereof. For example, the sensor data may include information corresponding to one or more external objects, such as pedestrians, remote vehicles, other objects within the vehicle operational environment, vehicle transportation network geometry, or a combination thereof. The sensors may include or be in communication with a global navigation satellite system (GNSS), a global position system (GPS), or both. As used herein, an AV encompasses a semi-autonomous vehicle.

During autonomous driving, and at different time steps (e.g., at every time step), some component (e.g., a decision-making module or model such as a reasoning module, an inference module, or the like) of the AV may determine a respective action for controlling the AV in response to sensor information. Thus, at a high level, the component of the AV uses inputs (e.g., sensor data) and produces an output (e.g., the action to control the AV) where the output can be an action for controlling the AV.

The component can be a single component (e.g., module, model, circuitry, etc.), multiple cooperating components, or a command arbitration module (e.g., an executor or an autonomous vehicle operational management controller) that receives inputs (e.g., candidate actions) from multiple components and selects one of the candidate actions as the selected action for controlling the AV. However, at times during autonomous control or semi-autonomous control the AV may lose contact with the GNSS, GPS, or both and the AV may estimate lane structures in order to maintain the AV within a given lane.

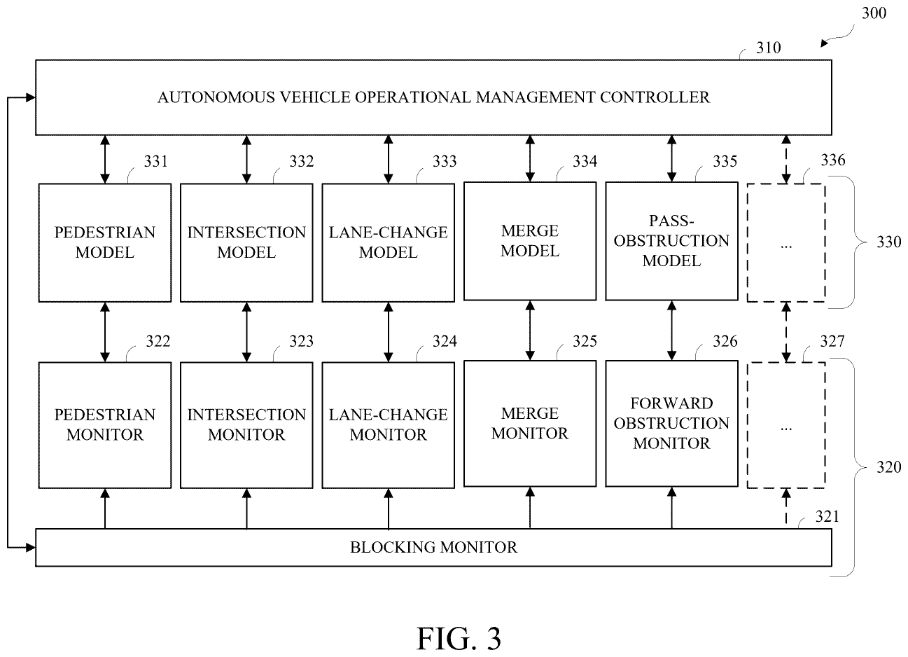

Certain of the components may be referred to as decision components herein. Each decision component recommends an action based on a belief state of the operational environment of the vehicle (e.g., a state based on the locations of objects and the AV, headings, speed, etc.), which belief state is described in additional detail below with regards to FIG. 3. The decision component may explicitly maintain the belief state. In such an implementation, the belief state is updated using the current belief state, an observation made (e.g., by an observation monitor or model), the selected action, sensors, prior data, LIDAR, landmarks, non-autonomous driving, or a combination thereof. During real-time decision-making, the decision component explicitly maintaining the belief state may provide estimations to maintain the AV within a lane.

In the rapidly evolving landscape of autonomous vehicle technology, the safe and efficient operation of self-driving cars remains a challenge. As autonomous vehicles become more prevalent on our roads, they rely on complex systems of sensors, algorithms, and decision-making models to navigate through diverse and dynamic environments. However, these sophisticated systems are not immune to faults or failures, which can potentially compromise the safety of the vehicle, its occupants, and other road users. The challenge lies in developing robust mechanisms to detect and respond to such faults in real-time, ensuring the continued safe operation of the autonomous vehicle.

One of the challenges in addressing faults in autonomous vehicles is the limited scope of the vehicle's own sensory and decision-making capabilities during a malfunction. When a system fails, the vehicle may lose its ability to accurately perceive its environment or make safe decisions, potentially leading to dangerous situations. Traditional fault detection and handling mechanisms that rely solely on the vehicle's internal systems may be insufficient in such scenarios. This presents a challenge in maintaining the safety and reliability of autonomous vehicles, especially in complex traffic situations or adverse environmental conditions.

Furthermore, the increasing complexity of autonomous driving systems introduces challenges in fault diagnosis and appropriate response selection. With multiple interconnected subsystems working in tandem, identifying the root cause of a fault and determining the most appropriate course of action in real-time becomes increasingly difficult. This challenge is compounded by the need for rapid decision-making in dynamic traffic environments, where even a momentary lapse in vehicle control can have consequences. Developing systems that can quickly and accurately assess faults, while also implementing safe and effective control strategies, remains a hurdle in advancing autonomous vehicle technology.

Implementations of this disclosure address problems such as these by providing a system and method for controlling a faulty autonomous vehicle using sensor data from another autonomous vehicle in the vicinity. The system may detect a fault associated with a second vehicle, obtain sensor data associated with a sensing region of the second vehicle, and provide an output, based on the sensor data, for controlling the second vehicle to traverse a vehicle transportation network. As used herein, the term “fault” may include, but is not limited to, a sensor fault, a communication fault, or a security fault that compromises the ability of an autonomous vehicle to safely operate. The term “sensing region” may refer to an area around a vehicle from which sensor data can be collected, which may include areas that are not directly observable by the vehicle's own sensors due to the fault.

Implementations of this disclosure may allow a first vehicle to assist in controlling a second vehicle that is experiencing a fault, thereby maintaining safe operation even when the second vehicle's own systems are compromised. This approach leverages the sensor capabilities and decision-making systems of nearby vehicles to provide a redundant layer of safety. The output provided for controlling the second vehicle may correspond to a control signal configured to control at least one of a steering system, an acceleration system, or a braking system of the second vehicle, allowing for comprehensive assistance in navigating the vehicle transportation network. In some implementations, the first vehicle may assist in controlling the second vehicle until the fault is resolved and/or until the second vehicle is in a safe location (e.g., a side of the road or a parking lot).

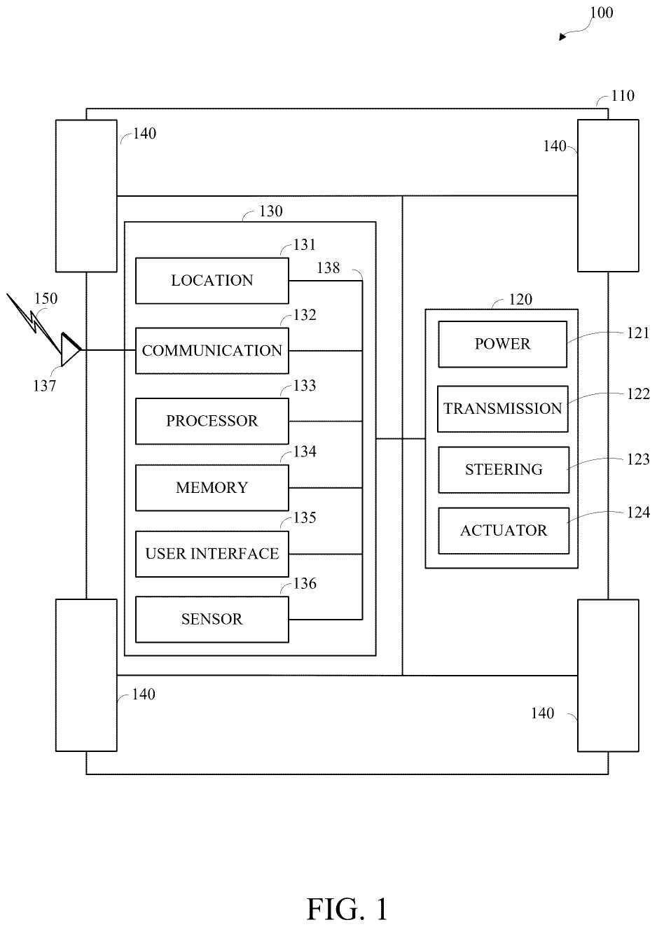

FIG. 1 is a diagram of an example of a vehicle in which the aspects, features, and elements disclosed herein may be implemented. As shown, a vehicle 100 includes a chassis 110, a powertrain 120, a controller 130, and wheels 140. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 (e.g., gas or electric) and may communicate with the powertrain 120, the wheels 140, or both, to control the vehicle 100, which may include accelerating, decelerating, steering, or otherwise controlling the vehicle 100.

As shown, the powertrain 120 includes a power source 121, a transmission 122, a steering unit 123, and an actuator 124. Other elements or combinations of elements of a powertrain, such as a suspension, a drive shaft, axles, or an exhaust system may be included. Although shown separately, the wheels 140 may be included in the powertrain 120.

The power source 121 may include an engine, a battery, or a combination thereof. The power source 121 may be any device or combination of devices operative to provide energy, such as electrical energy, thermal energy, or kinetic energy. For example, the power source 121 may include an engine, such as an internal combustion engine, an electric motor, or a combination of an internal combustion engine and an electric motor, and may be operative to provide kinetic energy as a motive force to one or more of the wheels 140. The power source 121 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 may receive energy, such as kinetic energy, from the power source 121, and may transmit the energy to the wheels 140 to provide a motive force. The transmission 122 may be controlled by the controller 130, the actuator 124, or both. The steering unit 123 may be controlled by the controller 130, the actuator 124, or both and may control the wheels 140 to steer the vehicle. The actuator 124 may receive signals from the controller 130 and may actuate or control the power source 121, the transmission 122, the steering unit 123, or any combination thereof to operate the vehicle 100.

As shown, the controller 130 may include a location unit 131, an electronic communication unit 132, a processor 133, a memory 134, a user interface 135, a sensor 136, an electronic communication interface 137, or any combination thereof. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 may be operatively coupled with the location unit 131, the memory 134, the electronic communication interface 137, the electronic communication unit 132, the user interface 135, the sensor 136, the powertrain 120, or any combination thereof. For example, the processor may be operatively coupled with the memory 134 via a communication bus 138.

The memory 134 may include any tangible non-transitory computer-usable or computer-readable medium, capable of, for example, containing, storing, communicating, or transporting machine readable instructions, or any information associated therewith, for use by or in connection with the processor 133. The memory 134 may include vehicle information, position information, lane information, road information, landmark information, city information, road intersection information, or a combination thereof. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. The communication interface 137 may be in communication with a satellite. Although FIG. 1 shows a single communication interface 137, a vehicle may include any number of communication interfaces.

The communication unit 132 may be configured to transmit and/or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, satellite signals, or a combination thereof. For example, the communication unit 132 may be configured to transmit and/or receive telecommunication protocols such as 4G, 5G, Long Term Evolution (LTE), and/or 6G, among other examples. The communication unit 132 may be configured to communicate via sidelink networks using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols, among other examples. Although FIG. 1 shows a single communication unit 132 and a single communication interface 137, any number of communication units and any number of communication interfaces may be used. The communication unit 132 may include a dedicated short-range communications (DSRC) unit, an on-board unit (OBU), or a combination thereof.

The location unit 131 may determine geolocation information, such as longitude, latitude, elevation, direction of travel, or speed, of the vehicle 100. For example, the location unit may include or be in communication with, a global positioning system (GPS) unit, a global navigation satellite system (GNSS), a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include an audio interface that performs audio communication with a person and a touch display that performs visual and touch-based communication with the person. The user interface 135 may include multiple displays, such as multiple physically separate units, multiple defined portions within a single physical unit, or a combination thereof.

The sensor 136 may include one or more sensors, such as an array of sensors, which may be operable to provide information that may be used to control the vehicle. The sensors 136 may provide information regarding current operating characteristics of the vehicle 100. The sensor 136 can include, for example, a speed sensor, acceleration sensors, a steering angle sensor, traction-related sensors, braking-related sensors, steering wheel position sensors, eye tracking sensors, seating position sensors, lidar, GPS. GNSS, internal measurement unit (IMU), cameras, or any sensor, or combination of sensors, operable to report information regarding some aspect of the current dynamic situation of the vehicle 100.

The sensor 136 may include one or more sensors operable to obtain information regarding the physical environment surrounding the vehicle 100. For example, one or more sensors may detect road geometry and features, such as lane lines, and obstacles, such as fixed obstacles, vehicles, pedestrians, pot holes, or a combination thereof. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 may be a combined unit.

The vehicle 100 may include a trajectory controller. For example, the controller 130 may include the trajectory controller. The trajectory controller may be operable to obtain information describing a current state of the vehicle 100 and a route planned for the vehicle 100, and, based on this information, to determine and estimate a trajectory for the vehicle 100. The trajectory controller may output signals operable to control the vehicle 100 such that the vehicle 100 follows the trajectory that is determined by the trajectory controller. For example, the output of the trajectory controller can be an estimated trajectory that may be supplied to the powertrain 120, the wheels 140, or both. The trajectory may be control inputs such as a set of steering angles, with each steering angle corresponding to a point in time or a position. The trajectory may be one or more paths, lines, curves, or a combination thereof.

One or more of the wheels 140 may be a steered wheel, which may be pivoted to a steering angle under control of the steering unit 123, a propelled wheel, which may be torqued to propel the vehicle 100 under control of the transmission 122, or a steered and propelled wheel that may steer and propel the vehicle 100.

A vehicle may include units, or elements, not expressly shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 100 may be an autonomous vehicle controlled autonomously, without direct human intervention, to traverse a portion of a vehicle transportation network. Although not shown separately in FIG. 1, an autonomous vehicle may include an autonomous vehicle control unit, which may perform autonomous vehicle routing, navigation, and control. The autonomous vehicle control unit may be integrated with another unit of the vehicle. For example, the controller 130 may include the autonomous vehicle control unit. The teachings herein are equally applicable to a semi-autonomous vehicle.

The autonomous vehicle control unit may control or operate the vehicle 100 to traverse a portion of the vehicle transportation network in accordance with current vehicle operation parameters. The autonomous vehicle may be controlled within the vehicle transportation network to move therein within a tolerance of one or more sides of the vehicle 100. For example, the vehicle 100 may move within the vehicle transportation network and maintain a distance of about 1 foot or less from a lane line. The autonomous vehicle control unit may control or operate the vehicle 100 to perform a defined operation or maneuver, such as parking the vehicle. The autonomous vehicle control unit may generate a route of travel from an origin, such as a current location of the vehicle 100, to a destination based on vehicle information, environment information, vehicle transportation network data representing the vehicle transportation network, or a combination thereof, and may control or operate the vehicle 100 to traverse the vehicle transportation network in accordance with the route. For example, the autonomous vehicle control unit may output the route of travel to the trajectory controller, and the trajectory controller may operate the vehicle 100 to travel from the origin to the destination using the generated route.

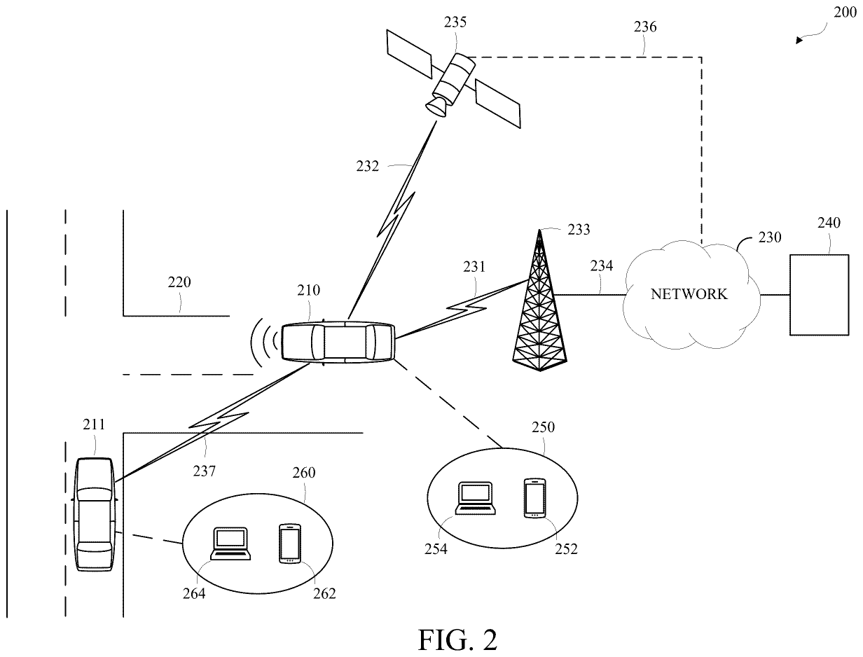

FIG. 2 is a diagram of an example of a portion of a vehicle transportation and communication system 200 in which the aspects, features, and elements disclosed herein may be implemented. The vehicle transportation and communication system 200 may include one or more vehicles 210/211, such as the vehicle 100 shown in FIG. 1, which may travel via one or more portions of one or more vehicle transportation networks 220, and may communicate via one or more electronic communication networks 230. Although not explicitly shown in FIG. 2, a vehicle may traverse an area that is not expressly or completely included in a vehicle transportation network, such as an off-road area.

The electronic communication network 230 may be, for example, a multiple access system and may provide for communication, such as voice communication, data communication, video communication, messaging communication, or a combination thereof, between the vehicle 210/211 and one or more communication devices 240. For example, a vehicle 210/211 may receive information, such as information representing the vehicle transportation network 220, from a communication device 240 via the network 230.

A vehicle 210/211 may communicate via a wired communication link (not shown), a wireless communication link 231/232/237, or a combination of any number of wired or wireless communication links. A vehicle 210/211 may communicate via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, a UV link, an RF link, or any link capable of providing for electronic communication.

A vehicle 210/211 may communicate with another vehicle 210/211. For example, a host, or subject, vehicle (HV) 210 may receive one or more automated inter-vehicle messages, such as a basic safety message (BSM), from a remote, or target, vehicle (RV) 211, via a direct communication link 237, or via a network 230. For example, the remote vehicle 211 may broadcast the message to host vehicles within a defined broadcast range, such as 300 meters. The host vehicle 210 may receive a message via a third party, such as a signal repeater (not shown) or another remote vehicle (not shown). A vehicle 210/211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, may be configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a central unit (CU), a distributed unit (DU), a radio unit (RU), an NR network node, a 6G network node, a transmission reception point (TRP), a mobility element of a network, a core network node, a network element, a network equipment, a wireless router, a wired router, a hub, a relay, a switch, or any similar wired or wireless device. Although shown as a single unit in FIG. 2, an access point may include any number of interconnected elements. An access point may be stationary or mobile.

The vehicle 210 may communicate with the communications network 230 via a satellite 235 or other non-terrestrial communication device. The satellite 235, which may include a computing device, may be configured to communicate with a vehicle 210, with a communication network 230, with one or more communication devices 240, or with a combination thereof via one or more communication links 232/236. Although shown as a single unit in FIG. 2, a satellite may include any number of interconnected elements.

An electronic communication network 230 may be any type of network configured to provide voice, data, or any other type of electronic communication. For example, the electronic communication network 230 may include a local area network (LAN), a wide area network (WAN), a virtual private network (VPN), a mobile or cellular telephone network, the Internet, or any other electronic communication system. The electronic communication network 230 may use a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit in FIG. 2, an electronic communication network may include any number of interconnected elements.

The vehicle 210 may identify a portion or condition of the vehicle transportation network 220. For example, the vehicle 210 may include one or more on-vehicle sensors, such as sensor 136 shown in FIG. 1, which may include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 220. The sensor data may include lane line data, remote vehicle location data, or both.

The vehicle 210 may traverse a portion or portions of one or more vehicle transportation networks 220 using information communicated via the network 230, such as information representing the vehicle transportation network 220, information identified by one or more on-vehicle sensors, or both.

FIG. 2 shows two vehicles 210, 211, one vehicle transportation network 220, one electronic communication network 230, and one communication device 240, any number of vehicles, networks, or computing devices may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the network 230, the vehicle 210 may communicate with the communication device 240 via any number of direct or indirect communication links. For example, the vehicle 210 may communicate with the communication device 240 via a direct communication link, such as a Bluetooth communication link.

A vehicle 210/211 may be associated with an entity 250/260, such as a driver, operator, or owner of the vehicle. An entity 250/260 associated with a vehicle 210/211 may be associated with one or more personal electronic devices 252/254/262/264, such as a smartphone 252/262 or a computer 254/264. A personal electronic device 252/254/262/264 may communicate with a corresponding vehicle 210/211 via a direct or indirect communication link. Although one entity 250/260 is shown as associated with a respective vehicle 210/211 in FIG. 2, any number of vehicles may be associated with an entity and any number of entities may be associated with a vehicle.

The vehicle transportation network 220 is shown as navigable areas (e.g., roads), but the vehicle transportation network 220 may also include one or more unnavigable areas, such as a building, one or more partially navigable areas, such as a parking areas, dirt roads, or pedestrian walkways, or a combination thereof. The vehicle transportation network 220 may also include one or more interchanges between one or more navigable, or partially navigable, areas. A portion of the vehicle transportation network 220, such as a road, may include one or more lanes and may be associated with one or more directions of travel.

A vehicle transportation network 220, or a portion thereof, may be represented as vehicle transportation network data. For example, vehicle transportation network data 220 may be expressed as a hierarchy of elements, such as markup language elements, which may be stored in a database or file. For simplicity, the figures herein depict vehicle transportation network data representing portions of a vehicle transportation network 220 as diagrams or maps; however, vehicle transportation network data 220 may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

A portion, or a combination of portions, of the vehicle transportation network 220 may be identified as a point of interest or a destination. For example, the vehicle transportation network data may identify a building as a point of interest or destination. The point of interest or destination may be identified using a discrete uniquely identifiable geolocation. For example, the vehicle transportation network 220 may include a defined location, such as a street address, a postal address, a vehicle transportation network address, a GPS address, or a combination thereof for the destination.

The vehicles 210/211 may store the information from the vehicle transportation network 220 so that if communication with the network 230, the satellite 235, or both is lost the vehicles 210/211 may continue to autonomously control themselves. The stored information from the vehicle transportation network 220 may be used along with other information collected by the vehicles 210/211, the network 230, the satellite 235, or a combination thereof to control the vehicle 210/211 if communication with the network 230, the satellite 235, or both is lost.

FIG. 3 is a diagram of an example of an autonomous vehicle operational management system 300 in accordance with embodiments of this disclosure. The autonomous vehicle operational management system 300 may be implemented in an autonomous vehicle, such as the vehicle 100 shown in FIG. 1, one of the vehicles 210/211 shown in FIG. 2, a semi-autonomous vehicle, or any other vehicle implementing autonomous decision-making, at least in part.

The autonomous vehicle may traverse a vehicle transportation network, or a portion thereof, which may include traversing distinct vehicle operation scenarios. A distinct vehicle operation scenario may include any distinctly identifiable set of operative conditions that may affect the operation of the autonomous vehicle within a defined spatiotemporal area, or operational environment, of the autonomous vehicle. For example, a distinct vehicle operation scenario may be based on a number or cardinality of roads, road segments, or lanes that the autonomous vehicle may traverse within a defined spatiotemporal distance. In another example, a distinct vehicle operation scenario may be based on one or more traffic control devices that may affect the operation of the autonomous vehicle within a defined spatiotemporal area, or operational environment, of the autonomous vehicle. A distinct vehicle operation scenario may be based on one or more identifiable rules, regulations, or laws that may affect the operation of the autonomous vehicle within a defined spatiotemporal area, or operational environment, of the autonomous vehicle. A distinct vehicle operation scenario may be based on one or more identifiable external objects that may affect the operation of the autonomous vehicle within a defined spatiotemporal area, or operational environment, of the autonomous vehicle.

As shown in FIG. 3, the autonomous vehicle operational management system 300 includes an autonomous vehicle operational management controller (AVOMC) 310, operational environment monitors 320, and operation control evaluation modules (also referred to as models) 330.

The AVOMC 310 may control the vehicle to traverse the vehicle transportation network, or a portion thereof. Controlling the vehicle to traverse the vehicle transportation network may include, monitoring the operational environment of the vehicle, identifying or detecting distinct vehicle operation scenarios, identifying candidate vehicle control actions based on the distinct vehicle operation scenarios, and controlling the vehicle to traverse a portion of the vehicle transportation network in accordance with one or more of the candidate vehicle control actions.

The AVOMC 310 may receive, identify, or otherwise access, operational environment data representing an operational environment for the autonomous vehicle, such as a current operational environment or an expected operational environment, or one or more aspects thereof. The operational environment of the autonomous vehicle may include a distinctly identifiable set of operative conditions that may affect the operation of the autonomous vehicle within a defined spatiotemporal area of the autonomous vehicle, within a defined spatiotemporal area of an identified route for the autonomous vehicle, or a combination thereof. For example, operative conditions that may affect the operation of the autonomous vehicle may be identified based on sensor data, vehicle transportation network data, route data, or any other data or combination of data representing a defined or determined operational environment for the vehicle.

The operational environment data may include vehicle information for the autonomous vehicle, such as information indicating a geospatial location of the autonomous vehicle, information correlating the geospatial location of the autonomous vehicle to information representing the vehicle transportation network, a route of the autonomous vehicle, a speed of the autonomous vehicle, an acceleration state of the autonomous vehicle, passenger information of the autonomous vehicle, or any other information about the autonomous vehicle or the operation of the autonomous vehicle. The operational environment data may include information representing the vehicle transportation network proximate to the autonomous vehicle, an identified route for the autonomous vehicle, or both. For example, this may include information within a defined spatial distance, such as 300 meters, of portions of the vehicle transportation network along the identified route, information indicating the geometry of one or more aspects of the vehicle transportation network, information indicating a condition, such as a surface condition, of the vehicle transportation network, or any combination thereof.

The operational environment data may include information representing external objects within the operational environment of the autonomous vehicle, such as information representing pedestrians, non-human animals, non-motorized transportation devices, such as bicycles or skateboards, motorized transportation devices, such as remote vehicles, or any other external object or entity that may affect the operation of the autonomous vehicle.

Aspects of the operational environment of the autonomous vehicle may be represented within respective distinct vehicle operation scenarios. For example, the relative orientation, trajectory, expected path, of external objects may be represented within respective distinct vehicle operation scenarios. In another example, the relative geometry of the vehicle transportation network may be represented within respective distinct vehicle operation scenarios.

The autonomous vehicle may traverse multiple distinct vehicle operation scenarios within an operational environment, which may be aspects of a compound vehicle operational scenario. For example, a pedestrian may approach the expected path for the autonomous vehicle traversing an intersection.

The autonomous vehicle operational management system 300 may operate or control the autonomous vehicle to traverse the distinct vehicle operation scenarios subject to defined constraints, such as safety constraints, legal constraints, physical constraints, user acceptability constraints, or any other constraint or combination of constraints that may be defined or derived for the operation of the autonomous vehicle.

The AVOMC 310 may monitor the operational environment of the autonomous vehicle, or defined aspects thereof. Monitoring the operational environment of the autonomous vehicle may include identifying and tracking external objects, identifying distinct vehicle operation scenarios, or a combination thereof. For example, the AVOMC 310 may identify and track external objects within the operational environment of the autonomous vehicle. Identifying and tracking the external objects may include identifying spatiotemporal locations of respective external objects, which may be relative to the autonomous vehicle, identifying one or more expected paths for respective external objects, which may include identifying a speed, a trajectory, or both, for an external object. For simplicity and clarity, descriptions of locations, expected locations, paths, expected paths, and the like herein may omit express indications that the corresponding locations and paths refer to geospatial and temporal components; however, unless expressly indicated herein, or otherwise unambiguously clear from context, the locations, expected locations, paths, expected paths, and the like described herein may include geospatial components, temporal components, or both. Monitoring the operational environment of the autonomous vehicle may include using operational environment data received by the operational environment monitors 320.

The operational environment monitors 320 may include scenario-agnostic monitors, scenario-specific monitors, or a combination thereof. A scenario-agnostic monitor, such as a blocking monitor 321, may monitor the operational environment of the autonomous vehicle, generate operational environment information representing aspects of the operational environment of the autonomous vehicle, and output the operational environment information to one or more scenario-specific monitors, the AVOMC 310, or a combination thereof, as discussed in further detail below. A scenario-specific monitor, such as a pedestrian monitor 322, an intersection monitor 323, a lane-change monitor 324, a merge monitor 325, or a forward obstruction monitor 326, may monitor the operational environment of the autonomous vehicle, generate operational environment information representing scenario-specific aspects of the operational environment of the autonomous vehicle, and output the operational environment information to one or more operation control evaluation models 330, the AVOMC 310, or a combination thereof.

For example, the pedestrian monitor 322 may be an operational environment monitor for monitoring pedestrians, the intersection monitor 323 may be an operational environment monitor for monitoring intersections, the lane-change monitor 324 may be an operational environment monitor for monitoring lane-changes, the merge monitor 325 may be an operational environment monitor for merges, and the forward obstruction monitor 326 may be an operational environment monitor for monitoring forward obstructions. An operational environment monitor 327 is shown using broken lines to indicate that the autonomous vehicle operational management system 300 may include any number of operational environment monitors 320.

An operational environment monitor 320 may receive, or otherwise access, operational environment data, such as operational environment data generated or captured by one or more sensors of the autonomous vehicle, vehicle transportation network data, vehicle transportation network geometry data, route data, or a combination thereof. For example, the pedestrian monitor 322 may receive, or otherwise access, information, such as sensor data, which may indicate, correspond to, or may otherwise be associated with, one or more pedestrians in the operational environment of the autonomous vehicle. An operational environment monitor 320 may associate the operational environment data, or a portion thereof, with the operational environment, or an aspect thereof, such as with an external object, such as a pedestrian, a remote vehicle, or an aspect of the vehicle transportation network geometry.

An operational environment monitor 320 may generate, or otherwise identify, information representing one or more aspects of the operational environment, such as with an external object, such as a pedestrian, a remote vehicle, or an aspect of the vehicle transportation network geometry, which may include filtering, abstracting, or otherwise processing the operational environment data. An operational environment monitor 320 may output the information representing the one or more aspects of the operational environment to, or for access by, the AVOMC 310, such by storing the information representing the one or more aspects of the operational environment in a memory, such as the memory 134 shown in FIG. 1, of the autonomous vehicle accessible by the AVOMC 310, sending the information representing the one or more aspects of the operational environment to the AVOMC 310, or a combination thereof. An operational environment monitor 320 may output the operational environment information to one or more elements of the autonomous vehicle operational management system 300, such as the AVOMC 310. Although not shown in FIG. 3, a scenario-specific operational environment monitor 322, 323, 324, 325, 326 may output operational environment data or the derived operational environment information to a scenario-agnostic operational environment monitor, such as the blocking monitor 321.

The pedestrian monitor 322 may correlate, associate, or otherwise process the operational environment data to identify, track, or predict actions of one or more pedestrians. For example, the pedestrian monitor 322 may receive information, such as sensor data, from one or more sensors, which may correspond to one or more pedestrians, the pedestrian monitor 322 may associate the sensor data with one or more identified pedestrians, which may include identifying a direction of travel, a path, such as an expected path, a current or expected velocity, a current or expected acceleration rate, or a combination thereof for one or more of the respective identified pedestrians, and the pedestrian monitor 322 may output the identified, associated, or generated pedestrian information to, or for access by, the AVOMC 310.

The intersection monitor 323 may correlate, associate, or otherwise process the operational environment data to identify, track, or predict actions of one or more remote vehicles in the operational environment of the autonomous vehicle, to identify an intersection, or an aspect thereof, in the operational environment of the autonomous vehicle, to identify vehicle transportation network geometry, or a combination thereof. For example, the intersection monitor 323 may receive information, such as sensor data, from one or more sensors, which may correspond to one or more remote vehicles in the operational environment of the autonomous vehicle, the intersection, or one or more aspects thereof, in the operational environment of the autonomous vehicle, the vehicle transportation network geometry, or a combination thereof, the intersection monitor 323 may associate the sensor data with one or more identified remote vehicles in the operational environment of the autonomous vehicle, the intersection, or one or more aspects thereof, in the operational environment of the autonomous vehicle, the vehicle transportation network geometry, or a combination thereof, which may include identifying a current or expected direction of travel, a path, such as an expected path, a current or expected velocity, a current or expected acceleration rate, or a combination thereof for one or more of the respective identified remote vehicles. The intersection monitor 323 may output the identified, associated, or generated intersection information to, or for access by, the AVOMC 310.

The lane-change monitor 324 may correlate, associate, or otherwise process the operational environment data to identify, track, or predict actions of one or more remote vehicles in the operational environment of the autonomous vehicle, such as information indicating a slow or stationary remote vehicle along the expected path of the autonomous vehicle, to identify one or more aspects of the operational environment of the autonomous vehicle, such as vehicle transportation network geometry in the operational environment of the autonomous vehicle, or a combination thereof geospatially corresponding to a lane-change operation. For example, the lane-change monitor 324 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a lane-change operation, the lane-change monitor 324 may associate the sensor data with one or more identified remote vehicles in the operational environment of the autonomous vehicle, one or more aspects of the operational environment of the autonomous vehicle or a combination thereof geospatially corresponding to a lane-change operation, which may include identifying a current or expected direction of travel, a path, such as an expected path, a current or expected velocity, a current or expected acceleration rate, or a combination thereof for one or more of the respective identified remote vehicles. The lane-change monitor 324 may output the identified, associated, or generated lane-change information to, or for access by, the AVOMC 310.

The merge monitor 325 may correlate, associate, or otherwise process the operational environment information to identify, track, or predict actions of one or more remote vehicles in the operational environment of the autonomous vehicle, to identify one or more aspects of the operational environment of the autonomous vehicle, such as vehicle transportation network geometry in the operational environment of the autonomous vehicle, or a combination thereof geospatially corresponding to a merge operation. The merge monitor 325 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a merge operation, the merge monitor 325 may associate the sensor data with one or more identified remote vehicles in the operational environment of the autonomous vehicle, one or more aspects of the operational environment of the autonomous vehicle or a combination thereof geospatially corresponding to a merge operation, which may include identifying a current or expected direction of travel, a path, such as an expected path, a current or expected velocity, a current or expected acceleration rate, or a combination thereof for one or more of the respective identified remote vehicles. The merge monitor 325 may output the identified, associated, or generated merge information to, or for access by, the AVOMC 310.

The forward obstruction monitor 326 may correlate, associate, or otherwise process the operational environment information to identify one or more aspects of the operational environment of the autonomous vehicle geospatially corresponding to a forward pass-obstruction operation. For example, the forward obstruction monitor 326 may identify vehicle transportation network geometry in the operational environment of the autonomous vehicle. The forward obstruction monitor 326 may identify one or more obstructions or obstacles in the operational environment of the autonomous vehicle, such as a slow or stationary remote vehicle along the expected path of the autonomous vehicle or along an identified route for the autonomous vehicle; and the forward obstruction monitor 326 may identify, track, or predict actions of one or more remote vehicles in the operational environment of the autonomous vehicle. The forward obstruction monitor 326 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a forward pass-obstruction operation. The forward obstruction monitor 326 may associate the sensor data with one or more identified remote vehicles in the operational environment of the autonomous vehicle, one or more aspects of the operational environment of the autonomous vehicle or a combination thereof geospatially corresponding to the forward pass-obstruction operation, which may include may identifying a current or expected direction of travel, a path, such as an expected path, a current or expected velocity, a current or expected acceleration rate, or a combination thereof for one or more of the respective identified remote vehicles. The forward obstruction monitor 326 may output the identified, associated, or generated forward obstruction information to, or for access by, the AVOMC 310.

While shown as an operation environment monitor 320, the blocking monitor 321 may be a separate monitoring device. The blocking monitor 321 may receive operational environment data representing an operational environment, or an aspect thereof, for the vehicle. For example, the blocking monitor 321 may receive the operational environment data from the AVOMC 310, from a sensor of the vehicle, from an external device, such as a remote vehicle or an infrastructure device, or a combination thereof. The blocking monitor 321 may read the operational environment data, or a portion thereof, from a memory, such as a memory of the autonomous vehicle, such as the memory 134 shown in FIG. 1.

The blocking monitor 321, using this input, may determine a respective probability of availability (POA), or corresponding blocking probability, for one or more portions of the vehicle transportation network, such as portions of the vehicle transportation network proximal to the autonomous vehicle, which may include portions of the vehicle transportation network corresponding to an expected path of the autonomous vehicle, such as an expected path identified based on a current route of the autonomous vehicle. A probability of availability, or corresponding blocking probability, may indicate a probability or likelihood that the autonomous vehicle may traverse a portion of, or spatial location within, the vehicle transportation network safely, such as unimpeded by an external object, such as a remote vehicle or a pedestrian. For example, a portion of the vehicle transportation network may include an obstruction, such as a stationary object, and a probability of availability for the portion of the vehicle transportation network may be low, such as 0%, which may be expressed as a high blocking probability, such as 100%, for the portion of the vehicle transportation network. The blocking monitor 321 may identify a respective probability of availability for each of multiple portions of the vehicle transportation network within an operational environment, such as within 300 meters, of the autonomous vehicle. The blocking monitor 321 may determine, or update, probabilities of availability continually or periodically. The blocking monitor 321 may communicate probabilities of availability, or corresponding blocking probabilities, to the AVOMC 310.

A probability of availability may be indicated by the blocking monitor 321 corresponding to each external object in the operational environment of the autonomous vehicle and a geospatial area may be associated with multiple probabilities of availability corresponding to multiple external objects. An aggregate probability of availability may be indicated by the blocking monitor 321 corresponding to each type of external object in the operational environment of the autonomous vehicle, such as a probability of availability for pedestrians and a probability of availability for remote vehicles, and a geospatial area may be associated with multiple probabilities of availability corresponding to multiple external object types.

The blocking monitor 321 may identify external objects, track external objects, project location information, path information, or both for external objects, or a combination thereof. For example, the blocking monitor 321 may identify an external object and identify an expected path for the external object based on operational environment information (e.g., a current location of the external object), information indicating a current trajectory and/or speed for the external object, information indicating a type of classification of the external object (e.g., a pedestrian or a remote vehicle), vehicle transportation network information (e.g., a crosswalk proximate to the external object), previously identified or tracked information associated with the external object, or any combination thereof. The expected path may indicate a sequence of expected spatial locations, expected temporal locations, and corresponding probabilities.

The blocking monitor 321 may communicate probabilities of availability, or corresponding blocking probabilities, to the AVOMC 310. The AVOMC 310 may communicate the probabilities of availability, or corresponding blocking probabilities, to respective instantiated instances of the operational control evaluation modules 330.

The AVOMC 310 may identify one or more distinct vehicle operation scenarios based on one or more aspects of the operational environment represented by the operational environment information. For example, the AVOMC 310 may identify a distinct vehicle operation scenario in response to identifying, or based on, the operational environment information indicated by one or more of the operational environment monitors 320. The distinct vehicle operation scenario may be identified based on route data, sensor data, or a combination thereof. For example, the AVOMC 310 may identify one or multiple distinct vehicle operation scenarios corresponding to an identified route for the vehicle, such as based on map data corresponding to the identified route, in response to identifying the route. Multiple distinct vehicle operation scenarios may be identified based on one or more aspects of the operational environment represented by the operational environment information. For example, the operational environment information may include information representing a pedestrian approaching an intersection along an expected path for the autonomous vehicle, and the AVOMC 310 may identify a pedestrian vehicle operational scenario, an intersection vehicle operational scenario, or both.

The AVOMC 310 may instantiate respective instances of one or more of the operation control evaluation models 330 based on one or more aspects of the operational environment represented by the operational environment information, such as the identification of an upcoming scenario. An upcoming scenario may be a distinct vehicle operation scenario that the AVOMC 310 determines that the autonomous vehicle is likely to encounter if it continues in its path. Upcoming scenarios may be expected (e.g., can be determined from the route of the autonomous vehicle) or unexpected. An unexpected upcoming scenario may be a scenario that can be detected by the sensors of the vehicle and cannot be determined without sensor data.

The operation control evaluation models 330 may include scenario-specific operation control evaluation model (SSOCEMs), such as a pedestrian-SSOCEM 331, an intersection-SSOCEM 332, a lane-change-SSOCEM 333, a merge-SSOCEM 334, a pass-obstruction-SSOCEM 335, or a combination thereof. A SSOCEM 336 is shown using broken lines to indicate that the autonomous vehicle operational management system 300 may include any number of SSOCEMs 330. For example, the AVOMC 310 may instantiate an instance of a SSOCEM 330 in response to identifying a distinct vehicle operation scenario. The AVOMC 310 may instantiate multiple instances of one or more SSOCEMs 330 based on one or more aspects of the operational environment represented by the operational environment data. For example, the operational environment data may indicate two pedestrians in the operational environment of the autonomous vehicle and the AVOMC 310 may instantiate a respective instance of the pedestrian-SSOCEM 331 for each pedestrian.

The AVOMC 310 may send the operational environment information, or one or more aspects thereof, to another unit of the autonomous vehicle, such as the blocking monitor 321 or one or more instances of the SSOCEMs 330. For example, the AVOMC 310 may communicate the probabilities of availability, or corresponding blocking probabilities, received from the blocking monitor 321 to respective instantiated instances of the SSOCEMs 330. The AVOMC 310 may store the operational environment information, or one or more aspects thereof, such as in a memory, such as the memory 134 shown in FIG. 1, of the autonomous vehicle.

Although not expressly shown in FIG. 3, the autonomous vehicle operational management system 300 may include a predictor module that may generate and send prediction information to the blocking monitor 321, and the blocking monitor 321 may output probability of availability information to one or more of the other operational environment monitors 320.

A SSOCEM 330, once instantiated, can receive the operational environment information, which may include sensor data, to determine and output a candidate vehicle control action, also called a candidate action herein. A candidate action is a vehicle control action that is identified by the particular SSOCEM 330 as the likely optimal action for the vehicle to perform that will handle a particular scenario. For instance, a SSOCEM 330 configured to handle intersections (e.g., an intersection SSOCEM 332) may output a “proceed”, a candidate action that suggests proceeding through an intersection. At the same time, a SSOCEM 330 for handling lane changes (e.g., the lane change SSOCEM 333) may output a “turn left” candidate action indicating that the vehicle should merge left by two degrees. In some implementations, each SSOCEM 330 outputs a confidence score indicating a degree of confidence in the candidate action determined by the SSOCEM 330. For instance, a confidence score greater than 0.95 may indicate a very high confidence in the candidate action, while a confidence score less than 0.5 may indicate a relatively low degree of confidence in the candidate action. Further details of a SSOCEM 330 are described below.

The AVOMC 310 may receive one or more candidate actions from respective instances of the SSOCEMs 330. The AVOMC 310 may identify a vehicle control action from the candidate vehicle control actions, and may control the vehicle, or may provide the identified vehicle control action to another vehicle control unit, to traverse the vehicle transportation network in accordance with the vehicle control action.

A vehicle control action may indicate a vehicle control operation or maneuver, such as accelerating, decelerating, turning, stopping, or any other vehicle operation or combination of vehicle operations that may be performed by the autonomous vehicle in conjunction with traversing a portion of the vehicle transportation network. For example, an ‘advance’ vehicle control action may include slowly inching forward a short distance, such as a few inches or a foot; an ‘accelerate’ vehicle control action may include accelerating a defined acceleration rate, or at an acceleration rate within a defined range; a ‘decelerate’ vehicle control action may include decelerating a defined deceleration rate, or at a deceleration rate within a defined range; a ‘maintain’ vehicle control action may include maintaining current operational parameters, such as by maintaining a current velocity, a current path or route, or a current lane orientation; and a ‘proceed’ vehicle control action may include beginning or resuming a previously identified set of operational parameters. Although some vehicle control actions are described herein, other vehicle control actions may be used.

A vehicle control action may include one or more performance metrics. For example, a ‘stop’ vehicle control action may include a deceleration rate as a performance metric. In another example, a ‘proceed’ vehicle control action may expressly indicate route or path information, speed information, an acceleration rate, or a combination thereof as performance metrics, or may expressly or implicitly indicate that a current or previously identified path, speed, acceleration rate, or a combination thereof may be maintained.

A vehicle control action may be a compound vehicle control action, which may include a sequence, combination, or both of vehicle control actions. For example, an ‘advance’ vehicle control action may indicate a ‘stop’ vehicle control action, a subsequent ‘accelerate’ vehicle control action associated with a defined acceleration rate, and a subsequent ‘stop’ vehicle control action associated with a defined deceleration rate, such that controlling the autonomous vehicle in accordance with the ‘advance’ vehicle control action includes controlling the autonomous vehicle to slowly inch forward a short distance, such as a few inches or a foot.

The AVOMC 310 utilizes hardcoded logic to determine the vehicle control action from the candidate actions. For example, the AVOMC 310 may select the candidate action having the highest confidence score. The AVOMC 310 may select the candidate action that is the least likely to result in a collision. The AVOMC 310 may generate a compound action based on two or more non-conflicting candidate actions (e.g., compounding ‘proceed’ and ‘turn left by two degrees’ to result in a vehicle control action that causes the vehicle to veer left and proceed through an intersection). The AVOMC 310 may utilize a machine learning algorithm to determine a vehicle control action based on two or more differing candidate actions.

For example, identifying the vehicle control action from the candidate actions may include implementing a machine learning component, such as supervised learning of a classification problem, and training the machine learning component using examples, such as 1000 examples, of the corresponding vehicle operational scenario. In another example, identifying the vehicle control action from the candidate actions may include implementing a Markov Decision Process (MDP), or a Partially Observable Markov Decision Process (POMDP), which may describe how respective candidate actions affect subsequent candidate actions, and may include a reward function that outputs a positive or negative reward for respective vehicle control actions.

The AVOMC 310 may uninstantiate an instance of a SSOCEM 330. For example, the AVOMC 310 may identify a distinct set of operative conditions as indicating a distinct vehicle operation scenario for the autonomous vehicle, instantiate an instance of a SSOCEM 330 for the distinct vehicle operation scenario, monitor the operative conditions, subsequently determine that one or more of the operative conditions has expired, or has a probability of affecting the operation of the autonomous vehicle below a defined threshold, and the AVOMC 310 may uninstantiate the instance of the SSOCEM 330.

As referred to briefly above, a SSOCEM 330 may model a respective distinct vehicle operation scenario. The autonomous vehicle operational management system 300 includes any number of SSOCEMs 330, each modeling a respective distinct vehicle operation scenario. Modeling a distinct vehicle operation scenario may include generating and/or maintaining state information representing aspects of an operational environment of the vehicle corresponding to the distinct vehicle operation scenario, identifying potential interactions among the modeled aspects respective of the corresponding states, and determining a candidate action that solves the model. Stated more simply, a SSOCEM 330 may include one or more models that are configured to determine one or more vehicle control actions for handling a scenario given a set of inputs. The models may include, but are not limited to, POMDP models, MDP models, Classical Planning (CP) models, Partially Observable Stochastic Game (POSG) models, Decentralized Partially Observable Markov Decision Process (Dec-POMDP) models, Reinforcement Learning (RL) models, artificial neural networks, hardcoded expert logic, or any other suitable types of models. Examples of different types of models are provided below. Each SSOCEM 330 includes computer-executable instructions that define a manner by which the models, e.g., decision process models, operate and a manner by which the models are utilized.

A SSOCEM 330 may implement a discrete time stochastic control process, such as a POMDP model, which may be a single-agent model that models a distinct vehicle operation scenario, which may include modeling uncertainty, using a set of states (S), a set of actions (A), a set of observations (Ω), a set of state transition probabilities (T), a set of conditional observation probabilities (O), a reward function (R), or a combination thereof. A POMDP model may be defined or described as a tuple <S, A, Ω, T, O, R>.

A state from the set of states (S), may represent a distinct condition of respective defined aspects, such as external objects and traffic control devices, of the operational environment of the autonomous vehicle that may probabilistically affect the operation of the autonomous vehicle at a discrete temporal location. A respective set of states (S) may be defined for each distinct vehicle operation scenario. Each state (state space) from a set of states (S) may include one or more defined state factors. Although some examples of state factors for some models are described herein, a model, including any model described herein, may include any number, or cardinality, of state factors. Each state factor may represent a defined aspect of the respective scenario and may have a respective defined set of values. Although some examples of state factor values for some state factors are described herein, a state factor, including any state factor described herein, may include any number, or cardinality, of values.

For example, a remote or external object operating in the proximity of the vehicle may affect the operation of the vehicle and may be represented in a model. The model may include representing the following identified or expected information for the remote object, such as a remote vehicle: its geospatial location, its path, heading, or both, its velocity, its acceleration or deceleration rate, or a combination thereof corresponding to a respective temporal location. A respective set of states may be defined for each distinct vehicle operation scenario. At instantiation, the current state of the model may correspond to a contemporaneous state or condition of the operating environment.

An action from the set of actions (A) may indicate an available vehicle control action at each state in the set of states (S). A respective set of actions may be defined for each distinct vehicle operation scenario. Each action (action space) from a set of actions (A) may include one or more defined action factors. Although some examples of action factors for some models are described herein, a model, including any model described herein, may include any number, or cardinality, of action factors. Each action factor may represent an available vehicle control action and may have a respective defined set of values. Although some examples of action factor values for some action factors are described herein, an action factor, including any action factor described herein, may include any number, or cardinality, of values.

An observation from the set of observations (Ω) may indicate available observable, measurable, or determinable data for each state from the set of states (S). A respective set of observations may be defined for each distinct vehicle operation scenario. Each observation (observation space), from a set of observations (Ω) may include one or more defined observation factors. Although some examples of observation factors for some models are described herein, a model, including any model described herein, may include any number, or cardinality, of observation factors. Each observation factor may represent available observations and may have a respective defined set of values. Although some examples of observation factor values for some observation factors are described herein, an observation factor, including any observation factor described herein, may include any number, or cardinality, of values.

A state transition probability from the set of state transition probabilities (T) may probabilistically represent changes to the operational environment of the autonomous vehicle, as represented by the set of states (S), responsive to the actions of the autonomous vehicle, as represented by the set of actions (A), which may be expressed as T:S×A×S→[0, 1]. A respective set of state transition probabilities (T) may be defined for each distinct vehicle operation scenario. Although some examples of state transition probabilities for some models are described herein, a model, including any model described herein, may include any number, or cardinality, of state transition probabilities. For example, each combination of a state, an action, and a subsequent state may be associated with a respective state transition probability.

The set of state transition probabilities may be identified based on the operational environment data. For example, the operational environment data may indicate an area type, such as urban or rural, a time of day, an ambient light level, weather conditions, traffic conditions, which may include expected traffic conditions, such as rush hour conditions, event-related traffic congestion, or holiday related driver behavior conditions, road conditions, jurisdictional conditions, such as country, state, or municipality conditions, or any other condition or combination of conditions that may affect the operation of the vehicle.

Examples of state transition probabilities associated with a pedestrian vehicle operational scenario may include a defined probability of a pedestrian jaywalking (e.g., based on a geospatial distance between the pedestrian and the respective road segment); a defined probability of a pedestrian stopping in an intersection; a defined probability of a pedestrian crossing at a crosswalk; a defined probability of a pedestrian yielding to the vehicle at a crosswalk; any other probability associated with a pedestrian vehicle operational scenario.

Examples of state transition probabilities associated with an intersection vehicle operational scenario may include a defined probability of a remote vehicle arriving at an intersection; a defined probability of a remote vehicle cutting-off the autonomous vehicle; a defined probability of a remote vehicle traversing an intersection immediately subsequent to, and in close proximity to, a second remote vehicle traversing the intersection, such as in the absence of a right-of-way (piggybacking); a defined probability of a remote vehicle stopping, adjacent to the intersection, in accordance with a traffic control device, regulation, or other indication of right-of-way, prior to traversing the intersection; a defined probability of a remote vehicle traversing the intersection; a defined probability of a remote vehicle diverging from an expected path proximal to the intersection; a defined probability of a remote vehicle diverging from an expected right-of-way priority; or any other probability associated with an intersection vehicle operational scenario.

Examples of state transition probabilities associated with a lane change vehicle operational scenario may include a defined probability of a remote vehicle changing velocity, such as a defined probability of a remote vehicle behind the vehicle increasing velocity or a defined probability of a remote vehicle in front of the vehicle decreasing velocity; a defined probability of a remote vehicle in front of the vehicle changing lanes; a defined probability of a remote vehicle proximate to the vehicle changing speed to allow the vehicle to merge into a lane; or any other probabilities associated with a lane change vehicle operational scenario.

A conditional observation probability from the set of conditional observation probabilities (O) may represent probabilities of making respective observations (Ω) based on the operational environment of the vehicle, as represented by the set of states (S), responsive to the actions of the vehicle, as represented by the set of actions (A), which may be represented as O:A×S×Ω→[0, 1]. A respective set of conditional observation probabilities (O) may be defined for each distinct vehicle operation scenario. Although some examples of state conditional observation probabilities for some models are described herein, a model, including any model described herein, may include any number, or cardinality, of conditional observation probabilities. For example, each combination of an action, a subsequent state, and an observation may be associated with a respective conditional observation probability.

An example may be illustrated with reference to an intersection that the vehicle is approaching by traversing a first road. Contemporaneously, a remote vehicle may approach the intersection by traversing a second road. The vehicle may identify and evaluate operational environment data, such as sensor data, corresponding to the intersection, which may include operational environment data corresponding to the remote vehicle. The operational environment data may be inaccurate, incomplete, or erroneous. The vehicle may identify information probabilistically identifying the remote vehicle, such as probabilistically identifying location information for the remote vehicle. The conditional observation probability corresponding to observing, or probabilistically identifying, the location of the remote vehicle represents the probability that the identified operational environment information accurately represents the location of the remote vehicle. A model, including any model described herein, may include any number, or cardinality, of conditional observation probabilities. For example, each combination of an action, a subsequent state, and an observation may be associated with a respective conditional observation probability.

The reward function (R) may determine a respective positive or negative (cost) value that may be accrued for each combination of state and action, which may represent an expected value of the autonomous vehicle traversing the vehicle transportation network from the corresponding state in accordance with the corresponding vehicle control action to the subsequent state, which may be expressed as R:S×A→ [symbol] .

Solving a model may include determining a policy or solution, which may be a function, that maximizes the accrued reward, which may be determined by evaluating the possible combinations of the elements of the tuple, such as <S, A, Ω, T, O, R>, that defines the model. A policy or solution may identify or output a reward maximized, or optimal, candidate vehicle control action based on identified belief state data. The identified belief state data, which may be probabilistic, may indicate current state data, such as a current set of state values for the respective model, or a probability for the current set of state values, and may correspond with a respective relative temporal location. For example, solving a MDP model may include identifying a state from the set of states, identifying an action from the set of actions, determining a subsequent, or successor, state from the set of states subsequent to simulating the action subject to the state transition probabilities. Each state may be associated with a corresponding utility value, and solving the MDP model may include determining respective utility values corresponding to each possible combination of state, action, and subsequent state. The utility value of the subsequent state may be identified as the maximum identified utility value subject to a reward or penalty, which may be a discounted reward or penalty. The policy may indicate an action corresponding to the maximum utility value for a respective state. Solving a POMDP model is similar to solving the MDP model, except based probabilities for respective states and subject to observation probabilities corresponding generating observations for respective states. Where a probability is associated with a state within a POMDP model and other models that do not rely on discrete states, the states may be referred to as belief states. Thus, solving the SSOCEM model may include evaluating the possible state-action-state transitions and updating respective belief states, such as using Bayes'rule, particle filters, etc., based on respective actions and observations.

The autonomous vehicle operational management system 300 may include any number or combination of types of models. For example, the pedestrian-SSOCEM 331, the intersection-SSOCEM 332, the lane-change-SSOCEM 333, the merge-SSOCEM 334, and the pass-obstruction-SSOCEM 335 may be POMDP models. In another example, the pedestrian-SSOCEM 331 may be an MDP model and the intersection-SSOCEM 332 may be a POMDP model. The AVOMC 310 may instantiate any number of instances of the SSOCEMs 330 based on the operational environment data. A module 336 is shown using broken lines to indicate that the autonomous vehicle operational management system 300 may include any number or additional types of SSOCEMs 330. Although not expressly shown, in some embodiments an operational environment monitor 320 may identify occlusions, may identify or determine a probability that an external object is occluded, or hidden, by an identified occlusion, and may include occluded vehicle probability information in one or more SSOCEMs 330. In some implementations, the AVOMC 310 may instantiate an SSOCEM configured to generate an output for controlling an additional vehicle, as described herein.

One or more of the AVOMC 310, the operational environment monitors 320, or the SSOCEMs 330 may operate continuously or periodically, such as at a frequency of ten hertz (10 Hz). For example, the AVOMC 310 may identify a vehicle control action many times, such as ten times, per second. The operational frequency of each component of the autonomous vehicle operational management system 300 may be synchronized or unsynchronized, and the operational rate of one or more of the AVOMC 310, the operational environment monitors 320, or the SSOCEMs 330 may be independent of the operational rate of others.

The SSOCEMs 330 correspond to the decision components initially referenced. That is, a SSOCEM 330 can recommend an action based on the belief state of the operational environment of the vehicle. Where an SSOCEM 330 explicitly maintains a belief state, the belief state is updated using the current belief state, an observation made (e.g., by an observation monitor or model, such as one or more of the operational environment monitors 320), and the action selected by the SSOCEM 330. While this technique is useful for the off-line development of policy that maps any belief state to an action, problems can arise in real-time decision-making of an SSOCEM 330 due to sensor noise or errors, an error in the model, or both.

One problem may be illustrated by referring to FIG. 2. The vehicle 210 monitors the conditions of the operational environment, such as an upcoming scenario within the vehicle transportation network 220. For example, the vehicle 210 is approaching an intersection. The AVOMC 310 of the vehicle 210 may instantiate an instance of an intersection model 332, and more specifically a T-intersection model. Assume that a current belief state is 0.8 that the remote vehicle 211 is approaching the intersection and 0.2 that the remote vehicle 211 is at the intersection. The intersection monitor 323, due to sensor noise, may produce or otherwise generate an observation (e.g., an observation Ω) that the vehicle 211 is at a goal of the scenario (e.g., past the intersection). This observation is impossible given the belief state. Known techniques for updating the belief state, e.g., Bayes'rule, particle filters, Kalman filters, etc., fail where the observation is impossible given the (e.g., current) belief state. For example, the update may fail due to a division by 0. Thus, the intersection model 332 can fail to produce a candidate action.

Errors may result in the model, such as an SSOCEM 330. An error in the model, as observations are gained, may cause the model to update to any belief. More specifically, small errors such as an error in the probability of an observation and/or an error in how the operational environment transitions accumulate as the belief state is repeatedly updated. The belief state can drift in an incorrect direction (i.e., away from a belief state that reflects actual transportation network and the tracked object therein).

These problems may be addressed by modifying or replacing an operational environment monitor 320 as previously described such that the updated or new operational environment monitor determines or otherwise computes a belief state directly from raw perception of the operational environment (e.g., features sensed, determined, or otherwise perceived as the operational environment data described above). The operational environment monitor does so without relying on a belief update equation. The belief state is determined instead of or in addition to maintaining a belief state within an SSOCEM model. The belief state determination is particularly desirable for real-time decision-making of the vehicle.

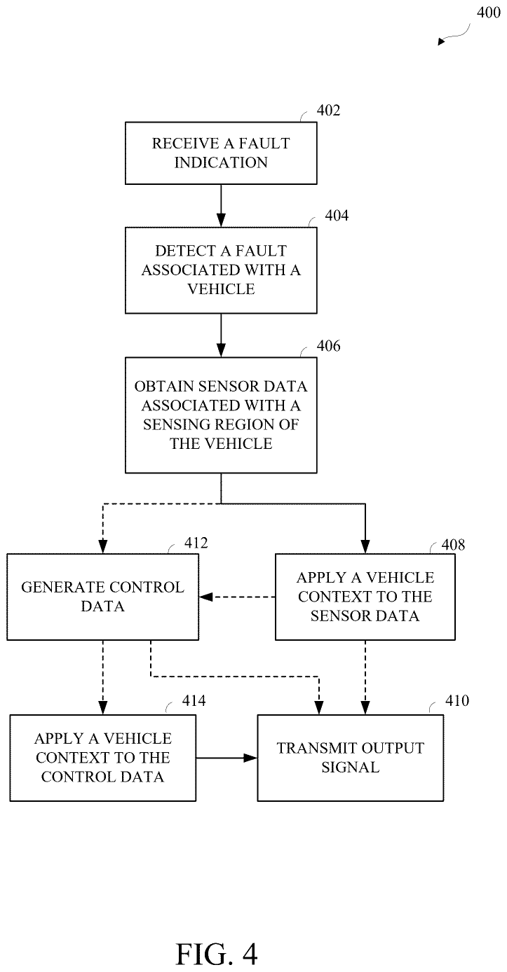

FIG. 4 illustrates a flowchart of a method 400 for managing a vehicle with a fault. The method 400 may be implemented in an apparatus of a first vehicle, such as the vehicle 100 shown in FIG. 1 or the host vehicle 210 shown in FIG. 2. The method 400 may be executed by a processor, such as the processor 133 shown in FIG. 1, configured to perform the steps described herein.

At 402, a fault indication is received by a first vehicle (and/or a component thereof). The fault indication may include a signal and/or an observation from indicative of a fault associated with a second vehicle. In some aspects, the fault indication may be received from a second vehicle, such as the remote vehicle 211 shown in FIG. 2. For example, the second vehicle may detect a fault associated with one of its systems or components and may transmit an indication of that fault to the first vehicle. In some aspects, the second vehicle may transmit the indication of the fault based on a determination that the first vehicle is within a sensing region of the second vehicle (e.g., a determination that the first vehicle is capable of obtaining sensor data associated with a region in which the second vehicle is located such that operation decisions can be made in view of that sensor data).

In some implementations, the first vehicle may be considered to be within a sensing region of the second vehicle through various means. This may include determining that the second vehicle is within a sensing region of the first vehicle, as the two conditions are often reciprocal. For instance, if the first vehicle's sensors can detect and gather data about the second vehicle, it may be inferred that the second vehicle's sensors could potentially detect the first vehicle as well. The sensing region may be defined by the range and capabilities of various sensor types, such as cameras, LiDAR, radar, or ultrasonic sensors, which may have different effective ranges and fields of view.

The first vehicle may be considered to be within a sensing region of the second vehicle based on identification of a shared or overlapping set of sensing regions between the two vehicles. In this scenario, both vehicles may be able to detect and gather information about a common area of the environment, which may include each other as well as other objects or vehicles. The extent of this overlap may vary depending on factors such as the vehicles'relative positions, the types of sensors they are equipped with, and environmental conditions that may affect sensor performance.

In some aspects, the fault indication may be detected by the first vehicle based on observed behavior of the second vehicle. A fault in a second vehicle may be detected by a first vehicle through various observational methods. The first vehicle may utilize its sensor suite, which may include cameras, LiDAR, radar, or other sensing technologies, to monitor the behavior and performance of the second vehicle. In some cases, the first vehicle may detect erratic movements or unexpected trajectories of the second vehicle, which may indicate a steering or control system fault. The first vehicle may also observe unusual speed fluctuations, such as sudden acceleration or deceleration, potentially signaling issues with the second vehicle's powertrain or braking system. Visual cues, such as smoke emission, unusual tire wear, or visible damage to the vehicle's exterior, may be detected by the first vehicle's optical sensors. Additionally, the first vehicle may analyze the second vehicle's adherence to traffic rules and lane positioning, as deviations from expected patterns may suggest a fault in the second vehicle's navigation or decision-making systems. In some implementations, the first vehicle may also monitor the second vehicle's communication patterns, where a sudden cessation or irregularity in data transmission could indicate a communication system fault.

The fault indication may correspond to various types of faults, including but not limited to sensor faults, communication faults, or security faults. Various types of faults may occur in the second vehicle that could potentially compromise its safe operation. Sensor faults may include malfunctions in the vehicle's LiDAR system, resulting in inaccurate distance measurements or blind spots in the vehicle's perception of its surroundings. Camera sensors may experience issues such as lens fogging or misalignment, leading to degraded image quality or incorrect object detection. In some cases, radar sensors may suffer from electromagnetic interference, causing false positives or missed detections of nearby objects. Communication faults may manifest as disruptions in the vehicle's connection to GPS satellites, potentially leading to inaccurate positioning information. The vehicle's cellular or dedicated short-range communication (DSRC) systems may experience signal loss or data corruption, hindering its ability to receive critical updates or communicate with other vehicles and infrastructure. Security faults may include unauthorized access to the vehicle's control systems, potentially allowing malicious actors to manipulate the vehicle's behavior remotely. In some instances, software vulnerabilities may be exploited to inject false sensor data or override the vehicle's decision-making algorithms, compromising its ability to navigate safely. Any number of other faults may be indicated by the fault indication.

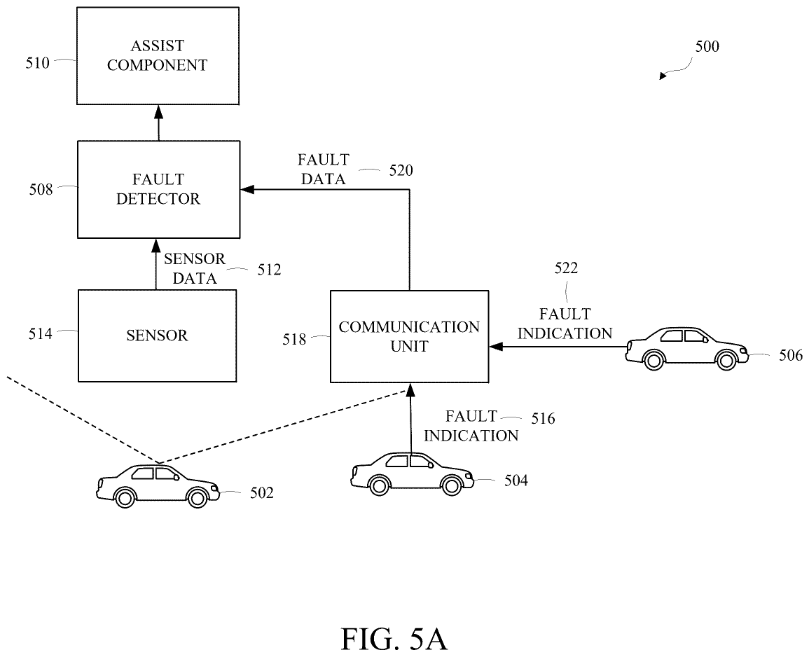

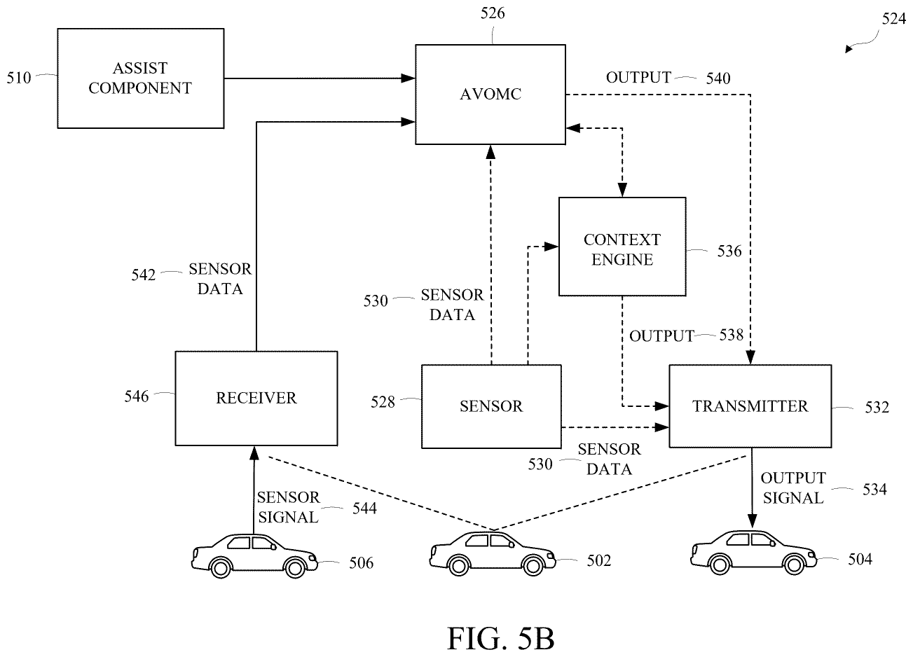

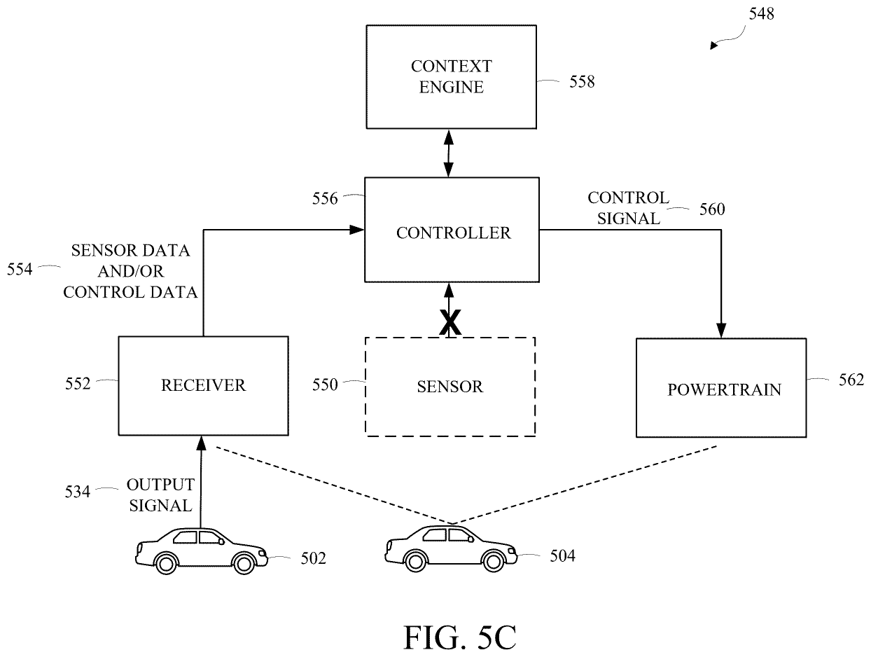

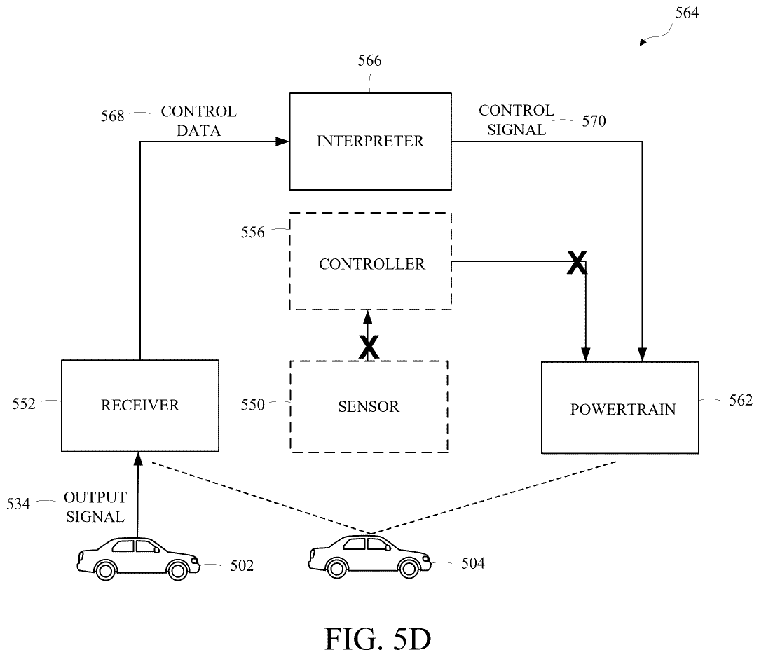

Based on the fault indication, at 404, a fault associated with the second vehicle is detected. Detecting the fault may include analyzing the received fault indication to determine the nature and/or severity of the fault. In some implementations, the fault detection may be performed by a fault detector, such as the fault detector 508 shown in FIG. 5A. The fault detection may involve processing sensor data, such as the sensor data 512 from the sensor 514, to identify anomalies or irregularities in the second vehicle's behavior, as described above.

Based on detection of the fault, at 406, the first vehicle may obtain sensor data associated with a sensing region of the second vehicle. For example, the first vehicle may acquire data from various types of sensors, which may include image data, radar data, and/or LiDAR data. In some aspects, obtaining the sensor data may include obtaining at least a portion of the sensor data from a roadside unit. In other implementations, at least a portion of the sensor data may be obtained from a third vehicle in the vicinity of the second vehicle.

As shown, at 408, a vehicle context may be applied to the sensor data. Applying the vehicle context may include analyzing the obtained sensor data in the context of the second vehicle's current situation, including its location, speed, and/or surrounding environment. The vehicle context may be determined by a context engine, such as the context engine 536 shown in FIG. 5B. Applying a vehicle context to the sensor data may refer to modifying and/or appending to the sensor data using contextual information associated with the vehicle experiencing the fault. This contextual information may include the vehicle's current location, speed, direction of travel, or any other relevant parameters. By applying the vehicle context, the method ensures that the sensor data is interpreted accurately within the specific circumstances of the vehicle experiencing the fault.

Optional paths are shown in FIG. 4 as dotted lines. For example, after the vehicle context is applied to the sensor data, an output signal may be transmitted to the second vehicle, at 410. The output signal may correspond to a control signal configured to control at least one of a steering system, an acceleration system, or a braking system of the vehicle. In some implementations, the output signal may be designed to control the vehicle to maneuver to a stopping location or an exit lane. In some aspects, after the vehicle context is applied, the sensor data with the context applied may be used to generate control data, at 412. The control data generation may take into account various factors such as the nature of the fault, the current traffic conditions, and the vehicle's capabilities.

In some implementations, the control data may be generated without applying the vehicle context to the sensor data as shown by the dotted arrow from 406 to 412. In some implementations, the output signal may be transmitted based on the control data, at 410. In some other implementations, as shown at 414, a vehicle context may be applied to the control data before transmitting the output signal based thereon. The additional context application ensures that the control data is further refined and tailored to the specific situation of the vehicle experiencing the fault. The vehicle context applied at this stage may include updated information about the vehicle's state or its surrounding environment.

FIGS. 5A-5D illustrate various aspects of a system and method for controlling a vehicle experiencing a fault using sensor data from another vehicle. This disclosure addresses the critical problem of maintaining safe operation of autonomous vehicles when their own systems are compromised, by leveraging the capabilities of nearby vehicles to provide assistance.

FIG. 5A illustrates a block diagram of an example 500 associated with using a first vehicle to assist a second vehicle with control. The example 500 includes a first vehicle 502, a second vehicle 504, and a third vehicle 506. Any one or more of the first vehicle 502, the second vehicle 504, and the third vehicle 506 may be, be similar to, include, or be included in, the vehicle 100, shown in FIG. 1. As shown, the first vehicle 502 includes a fault detector 508 and an assist component 510.

In FIG. 5A, an example 500 is shown where a first vehicle 502 is configured to assist a second vehicle 504 experiencing a fault. The first vehicle 502 may include a fault detector 508 and an assist component 510. The fault detector 508 may be a hardware or software component configured to detect faults in other vehicles. As used herein, the term “fault” may refer to any malfunction or abnormal condition in a vehicle's systems that may compromise its safe operation. For example, a fault may include a sensor failure, a communication system malfunction, or a security breach.

The fault detector 508 may receive sensor data 512 from a sensor 514 of the first vehicle 502. The sensor 514 may be any type of sensor capable of gathering data about the surrounding environment, such as a camera, LiDAR, or radar sensor. The fault detector 508 may process this sensor data 512 to detect a fault associated with the second vehicle 504. In some implementations, the fault detector 508 may use machine learning algorithms to analyze the sensor data and identify patterns indicative of vehicle faults.

Upon detecting a fault, the fault detector 508 may instantiate, trigger, activate, and/or notify the assist component 510. The assist component 510 may be hardware, software, or a combination thereof configured to initiate an operation for assisting with controlling the second vehicle 504. This may involve generating control signals or coordinating with other systems in the first vehicle 502 to provide assistance to the second vehicle 504.

In some aspects, the first vehicle 502 may receive a fault indication 516 via a communication unit 518. The communication unit 518 may be a wireless transceiver capable of receiving and transmitting data between vehicles. The communication unit 518 may be, be similar to, include, or be included in the communication unit 132 shown in FIG. 1. The fault indication 516 may be a signal or message explicitly indicating the occurrence of a fault in the second vehicle 504. The communication unit 518 may process this fault indication to generate fault data 520, which may then be provided to the fault detector 508 for further analysis.

In some implementations, a fault indication 522 may be received from a third vehicle 506. A fault indication may refer to any type of indication (e.g., signal, data, etc.) indicative of a fault associated with the second vehicle 504. For example, the fault indication 516 and/or the fault indication 522 may explicitly indicate an occurrence of a fault associated with the second vehicle 504, a nature of the fault, a severity of the fault, and/or a cause of the fault, among other examples. In some implementations, the fault indication 516 and/or 522 may include sensor data indicative of a fault. Sensor data may be indicative of a fault if the sensor data is capable of being processed to cause the fault detector 508 to detect, based on the sensor data, a fault associated with the second vehicle 504. The third vehicle 506 may detect a fault in the second vehicle 504 that the first vehicle 502 has not yet observed, enhancing the overall safety of the vehicle network.

FIG. 5B is a schematic diagram illustrating an example 524 associated with using the first vehicle 502, shown in FIG. 5A, to facilitate control of the second vehicle 504, shown in FIG. 5A. Optional data flows are shown using dashed arrows in FIG. 5B. The assist component 510 may be connected to an AVOMC 526. The AVOMC 526 may be a central control unit responsible for managing the autonomous operations of the vehicle. Upon detection of a fault in the second vehicle 504, the assist component 510 may initiate an assist operation through the AVOMC 526, as described above in connection with FIG. 5A.

Although not illustrated in FIG. 5B, the assist component 510 may be connected to a sensor 528 and may, based on detection of the fault associated with the second vehicle 504, instantiate, invoke, or otherwise cause the sensor 528 to initiate an assist operation. The sensor 528 may refer to one or more sensors of the first vehicle 502. In some aspects the assist component 510 may include a controller that may coordinate operations of the one or more sensors 528.

In this example, a sensor 528 in the first vehicle 502 may provide sensor data 530 to various components for processing. The sensor data 530 may include information about the second vehicle 504 and its surrounding environment. As used herein, the term “sensor data” may refer to any information collected by a vehicle's sensors about its environment, including but not limited to visual data, distance measurements, and object detection data.

The sensor data 530 may be processed in several ways. In one implementation, it may be sent directly to a transmitter 532, which may then transmit an output signal 534 to the second vehicle 504. Alternatively, the sensor data 530 may be sent to a context engine 536, which may apply a vehicle context associated with the second vehicle 504 to the sensor data. As used herein, the term “vehicle context” may refer to information about a vehicle's current state and environment that provides additional context for interpreting sensor data or generating control signals. For example, vehicle context may include the vehicle's current speed, location, and nearby traffic conditions.

The context engine 536 may generate an output 538 based on the sensor data and the applied vehicle context. This output 538 may then be sent to the transmitter 532 for transmission to the second vehicle 504 as the output signal 534. This approach allows for more tailored and context-aware assistance to the second vehicle 504.

In some implementations, the sensor data 530 may be provided to the AVOMC 526, which may generate an output 540 based on this data. The AVOMC 526 may use complex decision-making algorithms to determine the best course of action for assisting the second vehicle 504. The AVOMC 526 may perform any one or more operations as described above in connection with FIG. 3. The operations may be performed so as to generate the output 540 that can be used to facilitate control of the second vehicle 504. In some implementations, the context engine 536 may apply a vehicle context, associated with the second vehicle 504, prior to providing the sensor data 530 to the AVOMC 526. In some other implementations, the AVOMC 526 may generate the output 540 based on the sensor data 530 without the vehicle context applied. As show, the output 540 may be provided to the transmitter 532, which may transmit the output signal 534 based thereon. In some implementations, the AVOMC 526 may provide the output 540 to the context engine 536, which may apply a vehicle context, associated with the second vehicle 504, to generate the output 538, prior to the transmitter transmitting the output signal 534. As is further shown in FIG. 5B, the AVOMC 526 may generate the output 540 based at least in part on sensor data 542 originating from the third vehicle 506. For example, the third vehicle 506 may obtain sensor data and transmit a sensor signal 544, which may be received by a receiver 546 of the first vehicle 502. The receiver 546 may provide the sensor data 542, based on the sensor signal 544, to the AVOMC 526. In some implementations, the receiver 546 may be, be similar to, include, or be included in, the communication unit 518 shown in FIG. 5A.

FIG. 5C illustrates an example 548 of how the second vehicle 504 may receive and process the assistance provided by the first vehicle 502. The second vehicle 504 includes a receiver 552 that receives the output signal 534 from the first vehicle 502. The receiver 552 may process this signal to generate sensor data and/or control data 554, which is then sent to a controller 556.

The controller 556 may be connected to a context engine 558 and a powertrain 562. The context engine 558 may provide additional contextual information to the controller 556, which may be used to interpret or modify the received data. Based on the input from the receiver 552 and the context engine 558, the controller 556 may generate a control signal 560 that is sent to the powertrain 562.

The powertrain 562 may receive the control signal 560 from the controller 556 and execute the necessary actions to control the second vehicle 504. This may include adjusting the vehicle's speed, direction, or other operational parameters. In this way, the second vehicle 504 can maintain safe operation even when its own sensors or control systems are compromised.

FIG. 5D shows an alternative example 564 where the first vehicle 502 may more directly control the second vehicle 504 experiencing a fault. In this case, the first vehicle 502 includes a receiver 552, an interpreter 566, and a powertrain 562. The receiver 552 receives an output signal 534 from the second vehicle 504, which may include information about the fault or the second vehicle's current state.

The interpreter 566 receives control data 568 and processes it to generate a control signal 570. The control signal 570 is then sent to the powertrain 562 of the first vehicle 502. This configuration allows the first vehicle 502 to potentially take more direct control of the second vehicle 504, compensating for faults in the second vehicle's sensor 550 and controller 556.

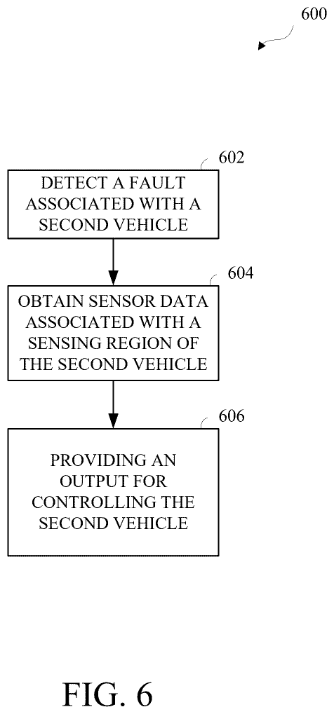

FIG. 6 illustrates a flowchart of a method 600 for controlling a vehicle experiencing a fault. This method may be implemented in an apparatus of a first vehicle, such as the vehicle 100 shown in FIG. 1, the host vehicle 210 shown in FIG. 2, or the first vehicle 502 shown in FIGS. 5A-5D.

Step 602 involves detecting a fault associated with a second vehicle. In some aspects, detecting the fault may include detecting at least one of a sensor fault, a communication fault, or a security fault. For example, the fault may be a malfunction in the second vehicle's LiDAR system, resulting in inaccurate distance measurements or blind spots in the vehicle's perception of its surroundings. In other implementations, the fault may be a disruption in the second vehicle's connection to GPS satellites, potentially leading to inaccurate positioning information.

The detection of the fault in step 602 may be based on various sources of information. In some implementations, the first vehicle may receive a fault indication from the second vehicle. For instance, the second vehicle may detect a fault associated with one of its systems or components and may transmit an indication of that fault to the first vehicle. In other cases, the fault may be detected based on observed behavior of the second vehicle. The first vehicle may utilize its sensor suite, which may include cameras, LiDAR, radar, or other sensing technologies, to monitor the behavior and performance of the second vehicle.

Step 604 involves obtaining sensor data associated with a sensing region of the second vehicle. This step may be performed after the fault has been detected in step 602. The sensor data may include various types of information, such as image data, radar data, or LiDAR data. In some implementations, obtaining the sensor data may include obtaining at least a portion of the sensor data from a roadside unit. This allows the first vehicle to gather information about the second vehicle's environment from fixed infrastructure along the road.

In other aspects of step 604, obtaining the sensor data may include obtaining at least a portion of the sensor data from a third vehicle. This implementation leverages the presence of other vehicles in the vicinity to gather additional information about the second vehicle's environment. For example, if the third vehicle has a better vantage point or different types of sensors, it may be able to provide valuable data that the first vehicle cannot obtain directly.

The sensor data obtained in step 604 may be processed in various ways before being used to control the second vehicle. In some implementations, a vehicle context may be applied to the sensor data. This may involve analyzing the obtained sensor data in the context of the second vehicle's current situation, including its location, speed, and surrounding environment. Applying a vehicle context to the sensor data may refer to modifying and/or appending to the sensor data using contextual information associated with the vehicle experiencing the fault.

Step 606 involves providing an output, based on the sensor data, for controlling the second vehicle to traverse a vehicle transportation network. This step represents the culmination of the method, where the information gathered and processed in the previous steps is used to generate a control output for the second vehicle. The output may correspond to a control signal configured to control at least one of a steering system, an acceleration system, or a braking system of the second vehicle.

In some implementations of step 606, the output may correspond to a control signal configured to control the second vehicle to maneuver to a stopping location. This may be appropriate in situations where the detected fault is severe and the safest course of action is to bring the vehicle to a stop. In other cases, the output may correspond to a control signal configured to control the second vehicle to maneuver to an exit lane, allowing the vehicle to safely leave the main flow of traffic.

The method 600 may include additional steps or variations not explicitly shown in FIG. 6. For example, after obtaining the sensor data in step 604, the method may include generating control data based on the sensor data. This control data generation may take into account various factors such as the nature of the fault, the current traffic conditions, and the vehicle's capabilities. In some implementations, a vehicle context may be applied to the control data before transmitting the output signal based thereon.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or” unless specified otherwise, or clear from context. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. An apparatus of a first vehicle comprising:
a processor configured to:
detect a fault associated with a second vehicle;
obtain sensor data associated with a sensing region of the second vehicle; and
provide an output, based on the sensor data, for controlling the second vehicle to traverse a vehicle transportation network.

2. The apparatus of claim 1, wherein the output corresponds to a control signal configured to control at least one of a steering system, an acceleration system, or a braking system of the second vehicle.

3. The apparatus of claim 1, wherein detecting the fault includes detecting at least one of a sensor fault, a communication fault, or a security fault.

4. The apparatus of claim 1, wherein obtaining the sensor data includes obtaining at least a portion of the sensor data from a roadside unit.

5. The apparatus of claim 1, wherein obtaining the sensor data includes obtaining the sensor data from a third vehicle.

6. The apparatus of claim 1, wherein the sensor data includes at least one of image data, radar data, or light detecting and ranging sensor (LiDAR) data.

7. The apparatus of claim 1, wherein the output corresponds to a control signal configured to control the second vehicle to maneuver the second vehicle to a stopping location.

8. The apparatus of claim 1, wherein the output corresponds to a control signal configured to control the second vehicle to maneuver the second vehicle to an exit lane.

9. A method for use with a first vehicle, comprising:
detecting a fault associated with a second vehicle;
obtaining sensor data associated with a sensing region of the second vehicle; and
providing an output, based on the sensor data, for controlling the second vehicle to traverse a vehicle transportation network.

10. The method of claim 9, wherein the output corresponds to a control signal configured to control at least one of a steering system, an acceleration system, or a braking system of the second vehicle.

11. The method of claim 9, wherein obtaining the sensor data includes obtaining at least a portion of the sensor data from a roadside unit.

12. The method of claim 9, wherein obtaining the sensor data includes obtaining at least a portion of the sensor data from a third vehicle.

13. The method of claim 9, wherein the sensor data includes at least one of image data, radar data, or light detecting and ranging sensor (LiDAR) data.

14. The method of claim 9, wherein the output corresponds to a control signal configured to control the second vehicle to maneuver the second vehicle to a stopping location.

15. The method of claim 9, wherein the output corresponds to a control signal configured to control the second vehicle to maneuver the second vehicle to an exit lane.

16. A first autonomous vehicle comprising:
a processor configured to execute instructions stored on a non-transitory computer readable medium to:
detect a fault associated with a second autonomous vehicle;
obtain sensor data associated with a sensing region of the second autonomous vehicle; and
provide an output, based on the sensor data, for controlling the second autonomous vehicle to traverse a vehicle transportation network.

17. The first autonomous vehicle of claim 16, wherein the output corresponds to a control signal configured to control at least one of a steering system, an acceleration system, or a braking system of the second vehicle.

18. The first autonomous vehicle of claim 16, wherein detecting the fault includes detecting at least one of a sensor fault, a communication fault, or a security fault.

19. The first autonomous vehicle of claim 16, wherein obtaining the sensor data includes obtaining at least a portion of the sensor data from a roadside unit.

20. The first autonomous vehicle of claim 16, wherein the output corresponds to a control signal configured to control the second vehicle to maneuver the second vehicle to a stopping location.
